(19) United States
(12) Patent Application Publication
(10) Pub. No.: US 2007/0279897 A1
(43) Pub. Date: Dec. 6, 2007

(54) NON-MAGNETIC AND NON-RADIO FREQUENCY INTERFERENCE SYSTEM FOR ILLUMINATION OF BACKLIT STATIC IMAGERY AND METHOD FOR PROVIDING PACIFICATION TO MAGNETIC RESONANCE IMAGING PATIENTS

(76) Inventor: William Witherspoon, Fairfield, IA (US)

Correspondence Address: SIMMONS PERRINE PLC, THIRD FLOOR TOWER PLACE, 22 SOUTH LINN STREET, IOWA CITY, IA, 52240, US

(21) Appl. No.: 10/707,914

(22) Filed: Jan. 23, 2004

(51) Int. Cl. F21S 8/00

(52) U.S. Cl. 362/147

(57) ABSTRACT

A system and method for illuminating a back lit translucent decorative panel(s) disposed in a hung ceiling frame, which includes an array of DC powered LEDs in an assembly which is non-ferrous and non-magnetic so as to facilitate use near MRI equipment.

### BACKGROUND OF INVENTION

In recent years, extremely sophisticated electronic equipment has been gaining widespread use in many fields, including medical imaging and secure communication environments. With these complex electronics, there is an increased need for reducing the impact on their optimal operation that conventional AC incandescent and fluorescent electrical lighting appliances may have. It has been known for years that light emitting diodes (LEDs), operating off a direct current (DC) power source is one way to reduce radio frequency interference (RFI). However, LEDs have typically been used for illumination as follows: city street stoplights, vehicle stoplights, large-scale digital signage equipment signal lights.

While these LEDs have been widely understood to perform with low RFI, they do have some drawbacks. LED arrays have been used in limited areas and have not been used to backlight large scale static decorative images to be displayed to a viewer.

Consequently, there exists a need for improved methods and systems for illuminating static decorative images in an efficient manner.

### SUMMARY OF INVENTION

It is an object of the present invention to provide a system and method for illuminating large scale static decorative imagery in an efficient manner.

It is a feature of the present invention to utilize an array of LEDs supported by a conventional hung panel ceiling grid configuration.

It is an advantage of the present invention to achieve improved efficiency in illumination without unacceptable RFI.

It is another feature of the present invention to include a non-magnetic, non-ferrous LED lamp fixture.

It is another advantage of the present invention to illuminate a decorative static image in close proximity to a magnetic resonance imaging (MRI) system.

It is another feature of the present invention to include risers within a lighting fixture structure that is compatible with a predetermined hung panel-type ceiling.

It is another advantage of the present invention to permit ease of insertion of a backlit decorative imagery panel into a hung ceiling system which is illuminated using LEDs.

It is yet another object of the present invention to provide a method of pacification of a nervous patient awaiting a magnetic resonance imaging (MRI) procedure.

It is a feature of the present invention to provide a large scale decorative panel or installation of multiple panels disposed in a hung ceiling in a room in close proximity to an MRI machine.

It is an advantage of the present invention to provide for pacification of nervous patients while awaiting an MRI procedure.

The present invention is an apparatus and method for illuminating decorative static imagery which is designed to satisfy the aforementioned needs, provide the previously stated objects, include the above-listed features, and achieve the already articulated advantages. The present invention is carried out in an “RFI-less” manner in a sense that the radio frequency interference typically associated with AC incandescent and fluorescent lamps, has been greatly reduced.

Accordingly, the present invention is a system and method comprising a non-ferrous and non-magnetic hood, an array of LEDs, and a plurality of risers on said hood configured to permit insertion of a decorative static imagery panel into a predetermined hung panel ceiling.

### BRIEF DESCRIPTION OF DRAWINGS

The invention may be more fully understood by reading the following description of the preferred embodiments of the invention, in conjunction with the appended drawings wherein:

FIG. 1 is an exploded perspective view of a system of the present invention, wherein the dashed lines show the connection to the parts due to the exploded nature of the figure, and where the dotted lines show the registration or alignment between less translucent areas and individual light emitting diodes.

### DETAILED DESCRIPTION

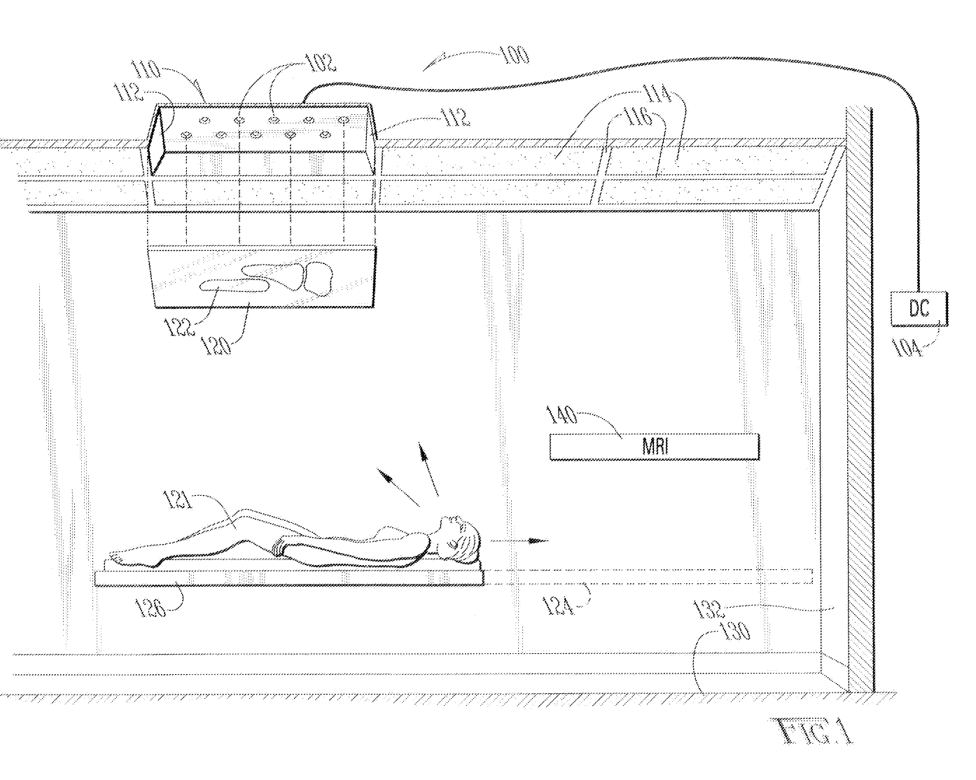

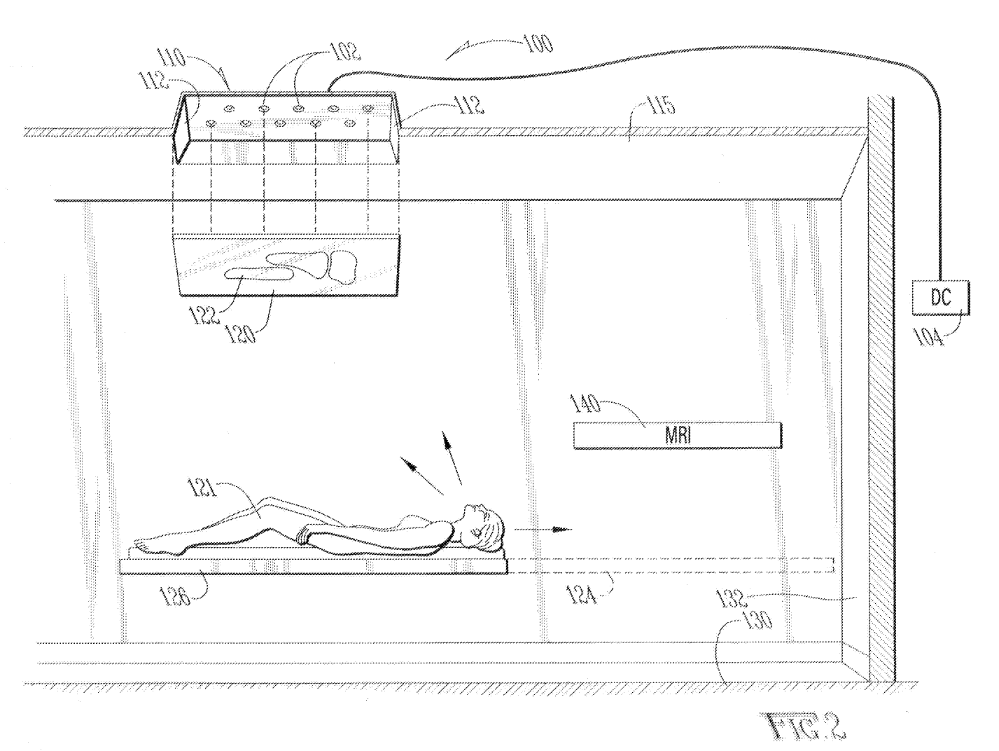

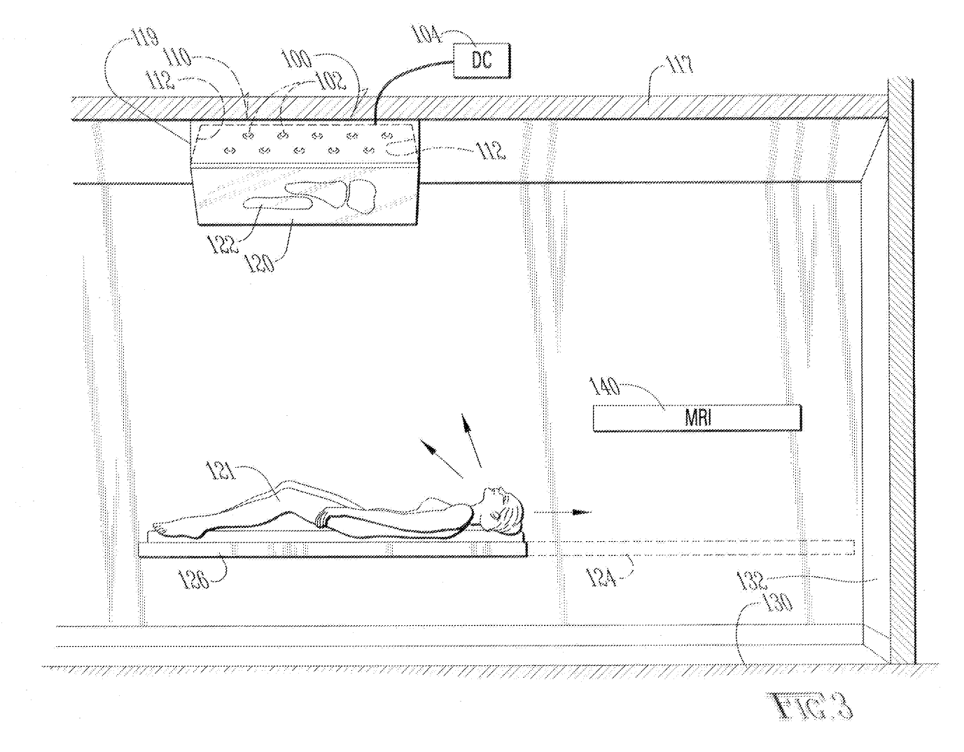

Now referring to the drawings wherein like numerals refer to like matter throughout, and more specifically referring to FIG. 1, there is shown a system of the present invention generally designated 100, including an array of LEDs 102 disposed in a LED lamp assembly 110. Each LCD of the array of LEDs 102 are preferably driven by a remotely located DC LED power source 104 for RF shielding and would preferably have an illumination angle of approximately 50 degrees or greater and would preferably output 50 to 300 lumens of light energy per square foot of panel surface evenly distributed across said surface and measured at the surface. Array of LEDs 102 are raised above the predetermined rectangular ceiling tile 114 by end risers 112 so as to facilitate ease of insertion of translucent decorative static imagery panel 120 with decorative static imagery 122 thereon and to insure proper distance between the LED array and the surface which is necessary to insure uniform light distribution on said surface. Preferably, when translucent decorative static imagery panel 120 is inserted, it is flush, with the numerous other predetermined rectangular translucent decorative static imagery panels or ceiling tiles 114 being suspended by predetermined rectangular ceiling tile frame 116.

In a preferred embodiment of the present invention, the LED lamp assembly 110 comprises all or nearly all non-magnetic and/or non-ferrous material and is disposed in an MRI room having an MRI room floor 130, and an MRI room wall 132 surrounded by an appropriate RF shielding. The non-ferrous and non-magnetic nature of the LED lamp assembly 110 provides for the ability to place it in close proximity to the MRI equipment 140. Similarly, the off-site, RF filtered DC LED power source 104 provides DC power which has greatly reduced electromagnetic interference (EMI) and RFI compared to AC powered incandescent and fluorescent lamps. The translucent decorative static imagery panel 120 is preferably positioned so as to be viewable by MRI procedure patient 121 while in the MRI procedure patient location 124 and in the MRI procedure patient waiting location 126. An MRI procedure patient 121 while awaiting a procedure with MRI equipment 140, preferably is able to see and be pacified by the decorative static imagery 122 displayed by translucent decorative static imagery panel 120.

Throughout this description, the terms “non-magnetic” and “non-ferrous” are used in relation to a preferred embodiment of the present invention which is capable of illumination in an environment such as that very near MRI equipment 140. This description is not intended to limit the present invention to only such non-magnetic or non-ferrous lamps. In fact, these terms are intended to encompass materials which are sufficiently non-ferrous and sufficiently non-magnetic so as not to interfere with either the operation of the MRI equipment 140 or the array of LEDs 102 when the MRI equipment 140 is being operated. It is contemplated that small amounts of ferrous or magnetic material may be used in LED lamp assembly 110 so long as it is less than a small fractional % by weight of the total weight of LED lamp assembly 110. Small fractional % of the entire weight means that ferrous material is of insufficient mass to overcome the total inertial mass of the unit and therefore will not cause movement of the unit even in the high gauss magnetic fields generated by MRI equipment.

In a preferred embodiment of the present invention, the decorative static imagery is a decorative static image of the sky, so that a patient awaiting a procedure may view said decorative static image while laying down in a face-up orientation or looking up from a seated or standing position. Said image is an accurate, photographically normal, (meaning it does not use forced perspective or permit the warping characteristic of wide angle or fish-eye lenses) representation of an authentic sky and may be coupled with equally authentic images of overhead vegetation such as trees in their various seasonal states, bare, blooming, leafy and colored or architectural elements such as buildings, ruins or garden lattice structures or natural formations such as cliffs, rocks or narrow canyons. Further, said image must accurately reproduce (within certain tolerances) the perspective and space that would be visible if a hole were cut in the facility ceiling and an actual real sky and/or foreground were to be viewed from the position of the observer within the facility. The claimant believes that viewing of images so constructed and properly installed in indoor ceilings, triggers in observers several beneficial effects that result in reduced stress and anxiety and an increased sense of peacefulness and well-being:

Objective changes in the physiology of the observer in the direction of restfulness and relaxation; and

Subjective changes in the psychology of the observer that indicate increased relaxation, peacefulness and sense of wellbeing, induced by remembering the experience of lying on ones back and looking up into the sky.

Other things to do to create images that trigger the appropriate response may include:

Use 6500K “daylight” light sources;

Eliminate reflection from all surfaces by using matte lamination films. Reflection gives away the fact that the image is close by, photographic, and not real;

Modify sky color with computer programs to correspond to desired humidity and altitude factors to produce the kind of sky that reads as that of a high pressure front (clear sky, feel-good days);

Use ceiling or other grids because they “tell” the civilized western viewer that what is next to the grid is actually beyond. This “telling” is a perceptual habit that results from the ubiquity of window moldings (grids) in our experience from childhood on up;

Calculate the correct position of the zenith for every installation, so that correct perception of space will occur for the observer(s);

Select non-threatening skies; and

Compose images using traditional principles of composition that repeatedly direct the attention of the observer in paths that bring their awareness to a field of open blue space where the attention is allowed to rest. This produces a meditative experience based on a recollection of the experience of the vastness of the sky.

In operation, the apparatus and method of the present invention could function as follows:

An array of LEDs 102 is provided in close proximity to MRI equipment 140. DC LED power source 104 is preferably remotely located in another room, or sufficiently shielded so as not to interfere with the operation of MRI equipment 140. Conventional RF filters can also be placed between the AC/DC power supply and the unit to eliminate RF noise within the DC supply lines that provide electricity to the LEDs array. The MRI procedure patient 121 is brought into the room and lies in an MRI procedure patient waiting location 126 where the decorative static imagery 122 of translucent decorative static imagery panel 120 is visible. Preferably, the decorative static imagery 122 is chosen so as to be a generally soothing or pacifying scene as described above. In some configurations such as an “Open MRI”, MRI procedure patient 121 may be able to view the decorative static imagery 122 during the procedure.

The present invention is described as having a reflector about an array of LEDs, because in many applications, this is preferred. However, in some applications where depth of the light unit is a concern, an edge light optical diffuser can replace the array with reflector combination.

While the above description is focused around lighting appliances which are used for overhead or ceiling applications, it should be understood that the present invention is intended to apply to non-ceiling applications and specifically to applications on walls and even floors. Of course, in both wall and floor applications, it should be understood that mere gravity alone may be insufficient for retaining the translucent panels in position.

It is thought that the method and apparatus of the present invention will be understood from the foregoing description and that it will be apparent that various changes may be made in the form, construct steps, and arrangement of the parts and steps thereof, without departing from the spirit and scope of the invention or sacrificing all of their material advantages. The form herein described is merely a preferred exemplary embodiment thereof.

1.

2. A system for illumination comprising:
an array of light emitting diodes (LEDs);
a direct current power source coupled to said array;
a predetermined rectangular ceiling tile frame comprising a plurality of rectangular openings, each of which is configured to receive and retain therein a predetermined rectangular ceiling tile; and,
a translucent panel, having a front side and a back side, said panel disposed in one of said plurality of rectangular openings and positioned so as to be uniformly lighted from said back side by said array.

3. A system of claim 2 wherein said array is disposed above said predetermined rectangular ceiling tile frame; and
said translucent panel having a decorative static image disposed thereon so as to be visible from said front side.

4. A system of claim 3 wherein said direct current power source is an alternating current to direct current power adapter which is separated from a magnetic resonance imaging device by more shielding structure than said predetermined rectangular ceiling tile and said predetermined rectangular ceiling tile frame.

5. A system of claim 3 wherein said array of LEDs is disposed in an LED lamp assembly comprising a hood with opposing end risers configured to facilitate:
insertion, without a need for flexing, of said translucent panel into said predetermined rectangular ceiling tile frame at a location below said array; and,
uniform dispersion of light onto said translucent panel.

6. A system of claim 5 wherein said array of LEDs emits light at an angle of at least 50 degrees.

7. A system of claim 5 wherein said translucent panel is chosen in response to a consideration of a mental characteristic of a patient who is about to be given a magnetic resonance imaging procedure.

8. (canceled)

9. A system of claim 7 further comprising:
predetermined patterns comprising images of a sky with a foreground being clouds; and,
wherein said hood and support structure for said array are comprised of aluminum.

10. A system of claim 9 wherein said predetermined rectangular ceiling tile frame is non-ferrous.

11. A system of claim 2 wherein said array is completely disposed in an overhead position in a room containing a magnetic resonance imaging system.

12. A system of claim 11 wherein said predetermined rectangular ceiling tile frame is a component of a fixture disposed below a non-hung grid ceiling of said room.

13. A system for illumination comprising:
a source of light in a lamp fixture;
a power source coupled to said source of light;
a predetermined rectangular ceiling tile frame comprising a plurality of rectangular openings, each of which is configured to receive and retain therein a predetermined rectangular ceiling tile; and,
a translucent panel, having a front side and a back side, said panel disposed in one of said plurality of rectangular openings and positioned so as to be uniformly lighted from said back side by said array;
said lamp fixture and said predetermined rectangular ceiling tile frame being configured with risers such that said translucent panel is insertable in said predetermined rectangular ceiling frame at a position below said lamp fixture without a need to flex said translucent panel and without using a hinging mechanism coupled to said panel; and,
said translucent panel comprising a decorative static image thereon of a scene of a sky with a foreground.

14-15. (canceled)

16. A system of claim 13 wherein said source of light is an array of light emitting diodes and said power source is a direct current power source.

17. A system of claim 16 wherein said array is disposed above a ceiling of a room containing a magnetic resonance imaging system and wherein said array is shrouded by an aluminum hood disposed so as to reflect light downward through said translucent panel.

18. A system of claim 17 wherein said room further contains a horizontal resting platform for a patient waiting to undergo a procedure with said magnetic resonance imaging system and further where said scene of a sky with a foreground has a predetermined orientation with respect to a zenith for said patient, when said patient is lying horizontally on said horizontal platform.

19. A system of claim 18 wherein said risers are made of aluminum.

20. A system of claim 19 wherein said direct current power source is located outside of said room and shielded from said magnetic resonance imaging system by structure which provides more shielding than provided by a ceiling structure and said lamp fixture.

21. A system for illumination comprising:
an array of light emitting diodes (LEDs);
a direct current power source coupled to said array;
a predetermined rectangular ceiling tile frame comprising a plurality of rectangular openings, each of which is configured to receive and retain therein a predetermined rectangular ceiling tile; and,
wherein the array of LEDs is disposed above one of said plurality of rectangular openings and positioned so as to uniformly light the space in the opening.

22. A system of claim 21 wherein said array is completely disposed in an overhead position in a room containing a magnetic resonance imaging system.

23. A system of claim 22 wherein said predetermined rectangular ceiling tile frame is a component of a fixture disposed below a non-hung grid ceiling of said room.

24. A system of claim 23 further comprising a translucent panel, having a front side and a back side, said panel disposed in one of said plurality of rectangular openings and positioned so as to be uniformly lighted from said back side by said array.
